(19) United States
(12) Patent Application Publication
(10) Pub. No.: US 2023/0028138 A1
(43) Pub. Date: Jan. 26, 2023

(54) MOTOR

(71) Applicant: TOYOTA JIDOSHA KABUSHIKI KAISHA, Aichi-ken (JP)

(72) Inventors: Dinh thanh LE, Toyota-shi, Aichi-ken (JP); Kenichi ICHINOSE, Toyota-shi (JP); Soichiro OTA, Toyota-shi (JP); Hiroshi YOSHIMOTO, Toyota-shi (JP)

(21) Appl. No.: 17/864,298

(22) Filed: Jul. 13, 2022

(30) Foreign Application Priority Data
Jul. 26, 2021 (JP) 2021-121944

(51) Int. Cl. H02K 5/08; H02K 5/173

(52) U.S. Cl. CPC H02K 5/08; H02K 5/1732

(57) ABSTRACT

A motor includes a rotor, a stator, and a case in which the rotor and the stator are stored. The rotor is electrically insulated from the case. Further, the stator may be also insulated from the case.

### CROSS-REFERENCE TO RELATED APPLICATION

This application claims priority to Japanese Patent Application No. 2021-121944 filed on Jul. 26, 2021, incorporated herein by reference in its entirety.

### BACKGROUND

### 1. Technical Field

The present disclosure relates to a configuration of a motor that can reduce common mode noise.

### 2. Description of Related Art

A motor driven by use of electric power outputs rotational driving force by a rotating field. Accordingly, noise caused by switching or the like of a switching element in an inverter is superimposed on a current or the like of a stator coil of the motor. This noise flows to the ground (GND) such as a case via a parasitic capacitance, so that common mode noise is caused.

In Japanese Unexamined Patent Application Publication No. 2009-194979 (JP 2009-194979 A), a power supply for a driving system of a motor and a power supply for a control system of the motor use different transformers so that they are electrically separated from each other, thereby preventing common mode noise caused in the driving system of the motor from mixing in the control system.

### SUMMARY

Here, in JP 2009-194979 A, respective transformers are provided in two power supply systems so that the two power supply systems are separated from each other. Because of this, an extra transformer is required. Further, common mode noise itself in the power supply for the driving system via the motor does not decrease, and therefore, it is also conceivable that this noise adversely affects other devices.

The present disclosure provides a motor including a rotor, a stator, and a case in which the rotor and the stator are stored. The rotor is electrically insulated from the case.

The stator may be electrically insulated from the case.

The motor may include a rotating shaft configured to rotate together with the rotor. The rotating shaft may be electrically insulated from the case.

A bearing may be provided in the case. The rotating shaft may be rotatably supported by the case via the bearing. The bearing may be electrically insulated from the case.

With the present disclosure, it is possible to reduce common mode noise of a motor and to restrain an adverse effect by the common mode noise.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a sectional view illustrating a configuration of a motor 100 according to an embodiment;

FIG. 2 is a view illustrating a configuration of a motor system configured to drive the motor 100;

FIG. 3 is a view illustrating part of the motor in which a stator is electrically connected to a case;

FIG. 4 is a view illustrating part of the motor 100 in which the stator is electrically insulated from the case;

FIG. 5 is a view illustrating the flow of common mode noise in a motor in which a stator is electrically connected to a case without an insulating material;

FIG. 6 is a view illustrating a configuration of an attachment portion between a stator core 14a and a case 16;

FIG. 7 is a view illustrating another configuration of the attachment portion between the stator core 14a and the case 16;

FIG. 8 is a sectional view illustrating part of a bearing 20 including an insulating material 26;

FIG. 9 is a view to describe a reduction effect of common mode noise by insulating a stator and a rotor from a case (GND) and is a view illustrating changes of the noise over time; and

FIG. 10 is a view to describe a reduction effect of common mode noise by insulating the stator and the rotor from the case (GND) and is a view illustrating the magnitude of noise in each of a U-phase, a V-phase, and a W-phase.

### DETAILED DESCRIPTION OF EMBODIMENTS

The following describes an embodiment of the present disclosure with reference to the drawings. Note that the present disclosure is not limited to the following embodiment.

Configuration of Motor

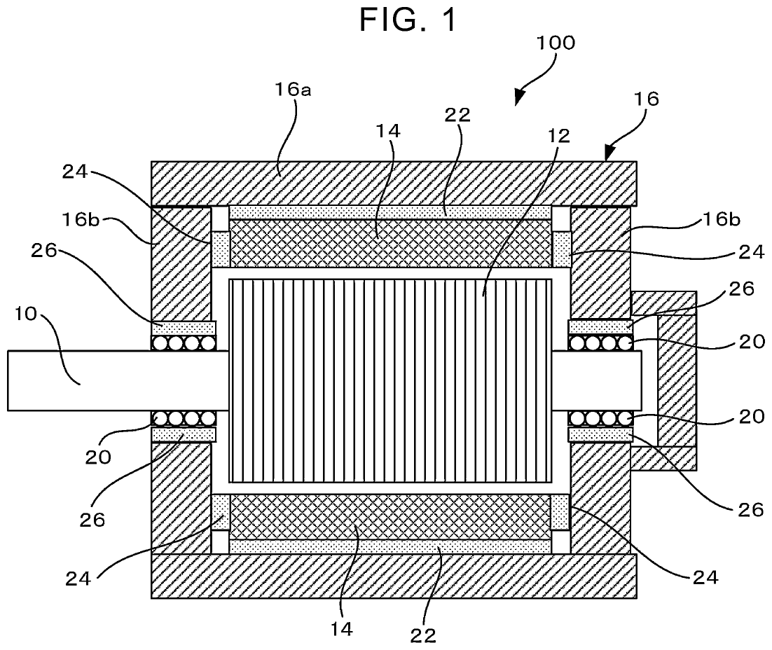

FIG. 1 is a sectional view illustrating a configuration of a motor 100 according to an embodiment. A cylindrical rotor 12 is attached to a rotating shaft 10, and a toric stator 14 is placed outside the rotor 12 via a predetermined gap. The rotor 12 includes a rotor core that is a magnetic body in which lamination steel sheets are laminated in the axial direction of the rotor 12, for example. Due to magnets embedded in the rotor core, a predetermined number of magnetic poles are formed at predetermined intervals in the circumferential direction of the rotor 12. The stator 14 is constituted by a magnetic body made of laminated steel sheets or the like and includes a plurality of teeth formed to project inwardly from a toric stator core. Stator coils of a predetermined number of phases are wound around the teeth.

A case 16 is provided to surround the toric stator 14, and the stator 14 is fixed to the case 16. The case 16 includes a peripheral wall 16a placed radially outwardly from the stator 14, and a pair of side walls 16b provided such that the side walls 16b are placed on both sides of the rotor 12 in the axial direction. Respective bearings 20 are provided in respective central parts of the side walls 16b such that the respective bearings 20 rotatably support the rotating shaft 10 at both sides of the rotor 12.

In such a motor 100, by forming a rotating field by causing alternating currents of a plurality of phases (e.g., three phases) to flow through the stator coils of the stator 14, the rotor 12 rotates, so that rotational driving force is output from the rotating shaft 10.

Here, the rotating shaft 10, the rotor 12, the stator 14, the case 16, and the bearings 20 are made of metal, that is, conductors. Accordingly, when these members make direct contact with each other, electricity flows therebetween.

In the present embodiment, an insulating material 22 is placed between the outer peripheral surface of the stator 14 and the peripheral wall 16a of the case 16, and an insulating material 24 is placed between an axial end surface of the stator 14 and the side wall 16b of the case 16, so that the stator 14 is insulated from the case 16.

Further, an insulating material 26 is placed between the bearing 20 and the side wall 16b of the case 16, so that the case 16 is insulated from the bearing 20, the rotating shaft 10, and the rotor 12. Accordingly, the stator 14 is insulated from the case 16, and the rotor 12 is insulated from the case 16.

System Configuration

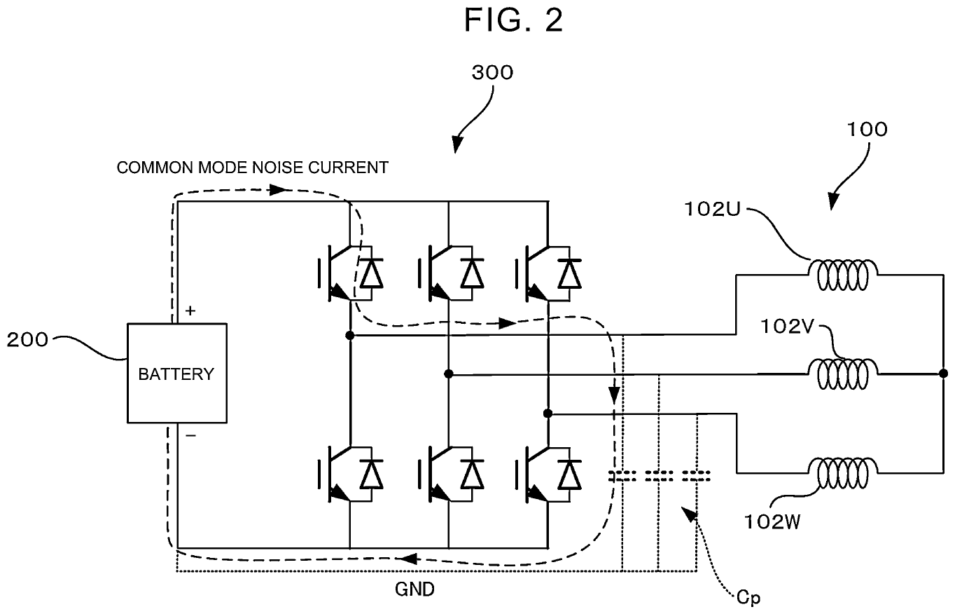

FIG. 2 illustrates a configuration of a motor system configured to drive the motor 100. The motor 100 is, for example, a driving motor of a battery electric vehicle (BEV) equipped with a battery. In view of this, direct-current power from an in-vehicle battery 200 is supplied to the motor 100 as alternating currents of three phases via an inverter 300.

The battery 200 is a secondary battery such as a lithium-ion battery and outputs several hundred volts of direct-current power. The inverter 300 includes three legs each constituted by a serial connection of two switching elements, and respective middle points of the legs serve as respective output points for motor driving currents of the three phases. The respective output points in the inverter 300 are connected to respective stator coils 102 (102U, 102V, 102W) of the three phases in the motor 100. In the present embodiment, second ends of the respective stator coils 102 (102U, 102V, 102W) of the three phases are connected together and form a star connection. Note that each of the two switching elements in one leg can be constituted by a parallel connection of a plurality of switching elements. That is, a switching element configured to apply a large current may be constituted by a plurality of switching elements connected in parallel to each other, instead of one large switching element.

Direct-current power from the battery 200 is supplied to the motor 100 as alternating currents having respective phases shifted by 120 degrees by switching of the switching elements in the inverter 300, and hereby, the motor 100 is rotationally driven.

Parasitic Capacitance Via Stator

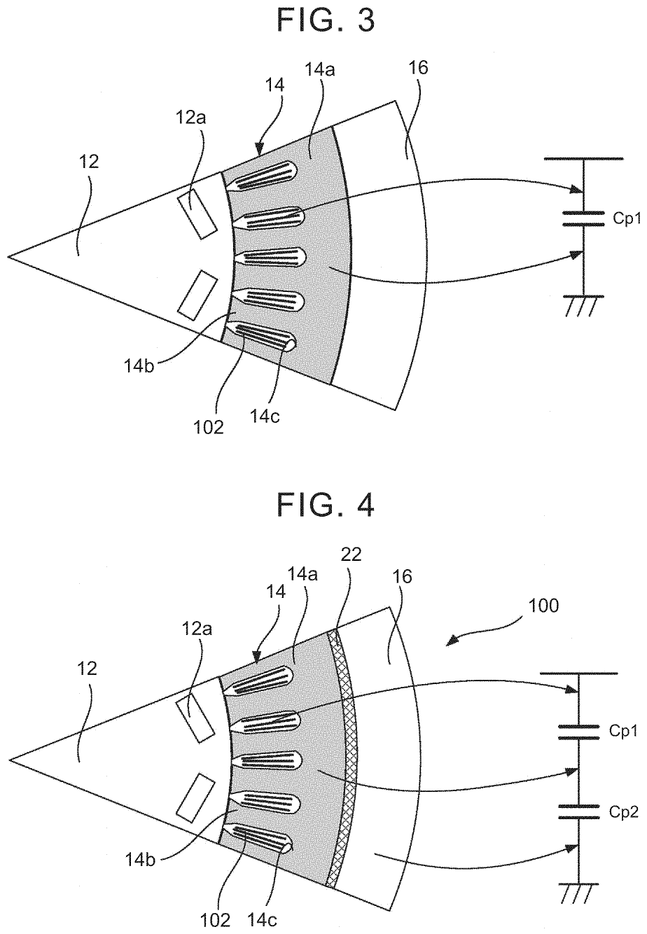

FIG. 3 is a view illustrating part of the motor in a case where the stator 14 is electrically connected to the case 16. Magnets 12a are embedded in a peripheral portion of the cylindrical rotor 12. The toric stator 14 is placed outwardly from the rotor 12. An outer peripheral side of the stator 14 serves as a stator core 14a, and slots 14c are formed between teeth 14b projecting inwardly from the stator core 14a. The case 16 is provided outwardly from the stator core 14a, and the case 16 is electrically connected to the stator core 14a.

Here, the stator coil 102 is wound around each of the teeth 14b of the stator core 14a. A coil wire rod of the stator coil 102 is coated with an insulation coating and is insulated from the stator core 14a. Meanwhile, as described above, the stator core 14a is electrically connected to the case 16. Generally, the case 16 is connected to GND.

In such a configuration, as indicated by dotted lines in FIG. 2, a parasitic capacitance Cp is present between the stator coil 102 and the GND. Accordingly, via the parasitic capacitance Cp, high-frequency noise of the stator coil 102 flows into a power-supply supply line of the battery 200 as common mode noise via the case 16. Note that the common mode noise flows through the three phases, but only the flow to the U-phase is illustrated an one example in the figure.

FIG. 5 is a view illustrating the flow of common mode noise in a motor in which the insulating materials 22, 24, 26 are not provided like FIG. 3. In FIG. 5, as indicated by broken lines, noise flows from the stator 14 to the case 16 and then flows into the GND. Note that, in FIG. 5, common mode noise flowing via the rotor 12 (described later) is also indicated by dotted lines.

Here, FIG. 3 illustrates a case where the stator core 14a is connected to the case 16. In this case, as illustrated on the right side in FIG. 3, the parasitic capacitance Cp is a parasitic capacitance Cp1 between the stator coil 102 and the stator core 14a (Cp=Cp1).

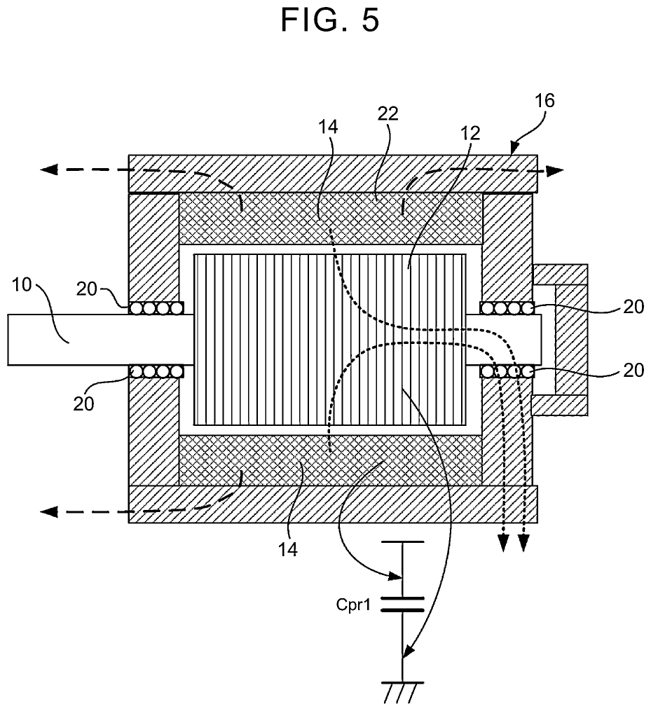

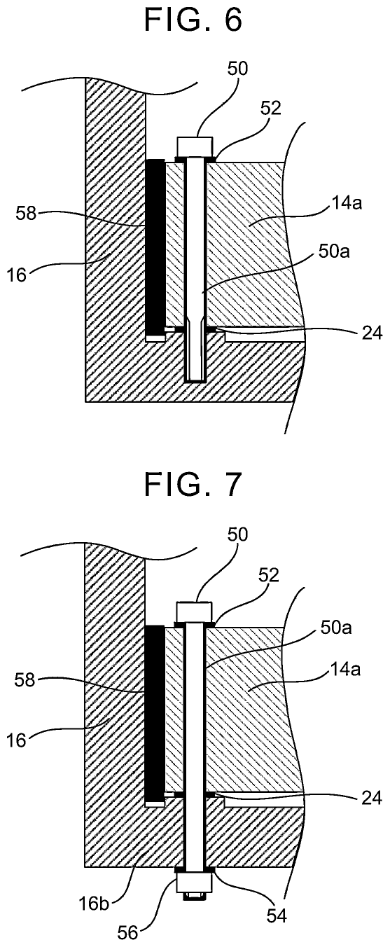

FIG. 4 illustrates a case where the stator core 14a is electrically insulated from the case 16 like the embodiment in FIG. 2. The configuration in FIG. 4 is similar to the configuration in FIG. 3 except that the insulating material 22 is placed between the stator 14 and the case 16. Even in this case, the parasitic capacitance between the stator core 14a and the case 16 cannot be made zero, and a small parasitic capacitance Cp2 is connected in series therebetween. The parasitic capacitance Cp between the stator coil 102 and the case (earth) in this case is expressed as Cp=Cp1 (1/(1+Cp1/Cp2)).

In a case where the stator core 14a can be properly insulated from the case 16 by the insulating material 22, Cp2 becomes very small. Accordingly, a parasitic capacitance on the stator coil 102 can be made small, thereby making it possible to reduce common mode noise on the power-supply supply line of the battery 200.

Parasitic Capacitance Via Rotor

As illustrated in FIG. 1, the rotor 12 is placed closer to the stator 14. Accordingly, a predetermined parasitic capacitance Cpr1 is present between the stator coil 102 and the rotor 12 as illustrated in FIG. 5, and noise of the stator coil 102 also flows into the rotor 12. When the rotor 12 is electrically connected to the rotating shaft 10, common mode noise also flows into the power-supply supply line of the battery 200 via the path through the rotor 12 and the rotating shaft 10.

Here, as illustrated in FIG. 1, when the rotating shaft 10 is insulated from the peripheral wall 16a of the case 16 by the insulating material 26, a parasitic capacitance from the stator coil 102 via the rotor 12 can be made small similarly to the above case of the stator 14, thereby making it possible to reduce common mode noise via the path through the rotor 12 and the rotating shaft 10.

Note that, as illustrated in FIG. 4, a parasitic capacitance of a path from the stator coil 102 to the case 16 via the stator core 14a and a parasitic capacitance of a path to the case 16 via the rotor 12 are parallel to each other, so that the parasitic capacitance is the sum of those parasitic capacitances.

Here, the rotating shaft 10 is electrically connected to the rotor 12. Accordingly, it is necessary to insulate the rotating shaft 10 so that the rotating shaft 10 is not electrically connected to the GND at a physical connection destination of the rotating shaft 10. In view of this, a connecting portion between the rotor 12 and the rotating shaft 10 may be insulated. In this case, an insulating material may be placed in the outer periphery of the rotating shaft, the shaft may be made of an insulating material, or a joint made of an insulating material may be used. Note that, in a case where the rotating shaft 10 is insulated on a side closer to the rotor 12 than the bearing 20, the insulating material 26 between the bearing 20 and the case 16 can be omitted.

Configuration of Insulation

FIG. 6 is a view illustrating a configuration of an attachment portion between the stator core 14a and the case 16. In this case, the stator core 14a is fixed to the case 16 by screwing a distal end of a bolt 50 into the case 16. The bolt 50 penetrates through the stator core 14a.

First, the insulating material 24 is placed as a spacer between the stator core 14a and the case 16. This avoids a direct electrical connection between the stator core 14a and the case 16. Further, an insulating material 58 is placed between the stator core 14a and the side wall of the case 16 on the outer peripheral side of the stator core 14a. The insulating material 58 may be air, but in consideration of vibration or the like, ceramic, plastic having a heat-resisting property (high-temperature resistance), or the like can be employed.

Further, in this example, the surface of the bolt 50 made of metal is coated with an insulating material 50a such as insulating varnish. Hereby, the stator core 14a is insulated from the bolt 50, thereby accordingly making it possible to prevent the stator core 14a from being electrically connected to the case 16 via the bolt 50. Further, a washer 52 made of an insulating material is placed between the head of the bolt 50 and the stator core 14a.

In this example, a distal-end threaded portion of the bolt 50 is also coated with the insulating material 50a. However, even when the distal-end threaded portion of the bolt 50 is electrically conductive, the bolt 50 and the case 16 are just electrically conductive with each other, and the stator core 14a and the case 16 are not conductive with each other. However, in order to surely insulate the stator core 14a by reducing the parasitic capacitance, it is preferable that the threaded portion be also insulated. Force is applied between the distal-end threaded portion of the bolt 50 and the case 16 at the time of fastening, and therefore, the insulation by the insulating varnish is easily broken. However, with the configuration of the present embodiment, even when the insulation between the bolt 50 and the case 16 cannot be maintained, this does not cause a large problem.

Further, it is also possible to omit the insulating coating or a washer made of an insulating material by forming the bolt 50 by use of an insulating material such as ceramic.

FIG. 7 is a view illustrating another configuration of the attachment portion between the stator core 14a and the case 16. In this example, the bolt 50 penetrates through the side wall 16b of the case 16 and is screwed into a nut 56 via a washer 54 made of an insulating material on the outer side of the case 16. Hereby, even when the bolt 50 is electrically conductive with the nut, it is possible to prevent electrical conduction between the bolt 50 and the case 16.

Note that the stator core 14a can be fixed to the case 16 such that both ends of the bolt 50 are placed outside the case 16 and are fastened with bolt nuts from outside the case 16.

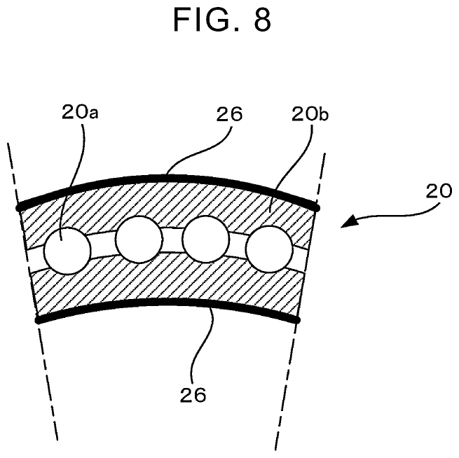

FIG. 8 is a sectional view illustrating part of one example of the bearing 20 including the insulating material 26. In this example, the bearing 20 is a ball bearing, and a plurality of ball 20a is rotatably held in grooves of paired bearing bodies 20b provided on both sides in the radial direction. Respective insulating materials 26 are provided on the rotating shaft 10 side that is the inner peripheral side of the paired bearing bodies 20b and on the case 16 side that is the outer peripheral side of the paired bearing bodies 20b. The insulating material 26 can be made of insulating varnish or the like. Note that the bearing 20 is not limited to a ball bearing, and it is possible to employ various bearings such as a taper bearing.

### Effects of Embodiment

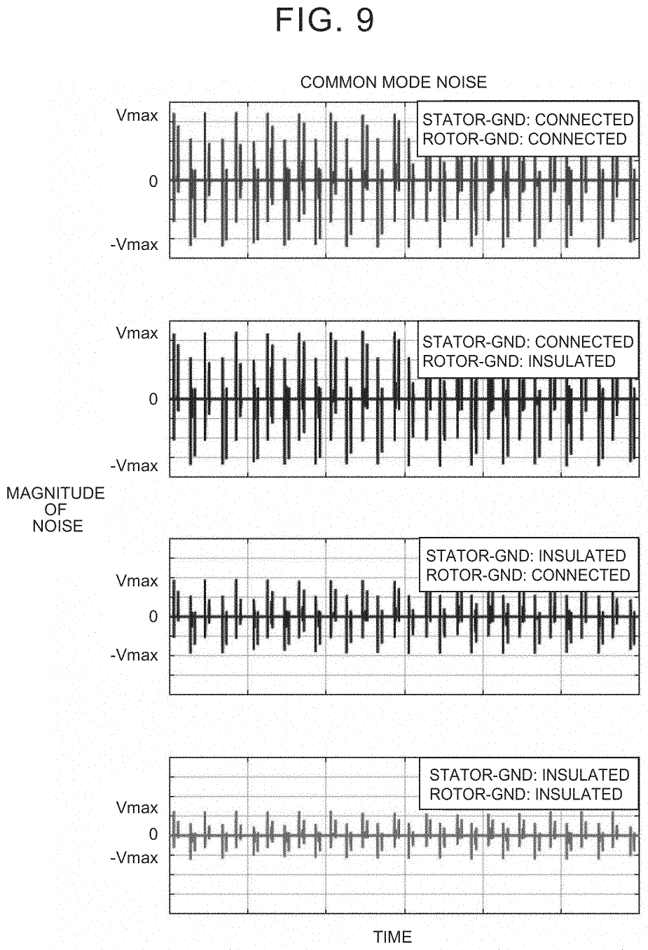

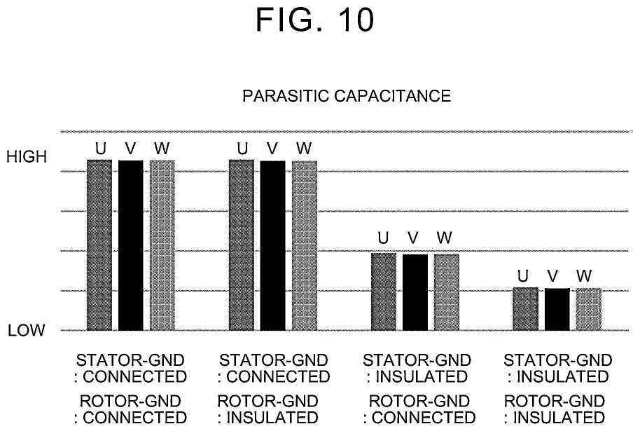

FIGS. 9, 10 are views to describe a reduction effect of common mode noise by insulating the stator 14 and the rotor 12 from the case 16 (GND). FIG. 9 illustrates views of changes of the noise over time, and FIG. 10 illustrates views of the magnitude of the noise in each of the U-phase, the V-phase, and the W-phase.

Thus, a considerable effect can be obtained by insulating the stator 14 from the case 16 (GND), and it is found that a large effect is obtainable by insulating the stator 14 and the rotor 12 from the case 16 (GND).

What is claimed is:

1. A motor comprising:
a rotor;
a stator; and
a case in which the rotor and the stator are stored, wherein the rotor is electrically insulated from the case.

2. The motor according to claim 1, wherein the stator is electrically insulated from the case.

3. The motor according to claim 1, wherein:
the motor includes a rotating shaft configured to rotate together with the rotor; and
the rotating shaft is electrically insulated from the case.

4. The motor according to claim 3, wherein:
a bearing is provided in the case;
the rotating shaft is rotatably supported by the case via the bearing; and
the bearing is electrically insulated from the case.
